(19) United States
(12) Patent Application Publication
(10) Pub. No.: US 2018/0151043 A1
(43) Pub. Date: May 31, 2018

(54) INTERACTIVE ALERTING METHOD AND SYSTEM FOR AN ELECTRONIC APPARATUS

(71) Applicant: TECOM Co., LTD., Hsin-Chu (TW)

(72) Inventor: Chao-Kai LIU, Hsin-Chu (TW)

(21) Appl. No.: 15/725,269

(22) Filed: Oct. 4, 2017

(30) Foreign Application Priority Data
Nov. 25, 2016 (TW) 105138819

(51) Int. Cl. G08B 19/00; G08B 21/18

(52) U.S. Cl. CPC G08B 19/00; G08B 21/18

(57) ABSTRACT

An interactive alerting method for an electronic apparatus is disclosed. The method receives and displays an alerting message once an abnormal situation occurs to the electronic apparatus. The method provides interactive questions to a user according to the type of the abnormal situation. Next, the method receives replies from the user aimed at the interactive questions, and obtains one or more causes of the abnormal situation according to the replies. Eventually, the method displays the obtained causes on a mobile device of the user. The cause of an abnormal situation occurs to an electronic apparatus is obtained via the replies aimed at interactive questions made by a user, which effectively increases the accuracy of the cause of the abnormal situation offered to the user.

### BACKGROUND OF THE INVENTION

### Field of the Invention

The invention relates to an alerting method for an electronic apparatus, in particular, the invention relates to an interactive alerting method and system for an electronic apparatus.

### Description of Prior Art

In order to simultaneous monitor the operation status of each electronic apparatus, manufacturers install one or several sets of sensors in various type of electronic apparatuses such as servers, power systems, motors, air conditioning apparatuses to sense various data of the electronic apparatuses such as voltages, currents, loads and temperatures etc. In addition, administrators install associated monitor applications in the computers or the mobile devices to directly inquire above sensor data in the computers or mobile devices.

In order to resolve abnormal situations soon after the abnormal situations occur to the electronic apparatuses, the current monitor systems proactively send alerts (such as message broadcasting) in the above mentioned computers or the mobile devices when the abnormal situations occur to the electronic apparatuses to immediately inform the administrators to resolve the abnormal situations in the field in addition to passively receiving the inquires of the above mentioned sensor data by the administrators.

As the technology advances, a part of the monitor systems in the market perform computing of the automatically obtained sensor data with high performance processors and preliminarily diagnose the abnormal situations of the electronic apparatuses and provide causes.

However, the causes of the abnormal situations diversify. The administrators may find it difficult to process all the potential causes directly offered to the administrators after the monitor systems preliminarily diagnosed the abnormal situations. Further, given the exact causes of the abnormal situations are not directly determined, providing the causes to the administrators may not be helpful to resolve the abnormal situations.

### SUMMARY OF THE INVENTION

An interactive alerting method for an electronic apparatus and an alerting system is disclosed in the present invention. The method and system obtain the cause of an abnormal situation in an electronic apparatus via the replies to interactive questions, which effectively increases the accuracy of the obtained cause of the abnormal situation.

In an embodiment according to the present invention, the method receives and displays an alerting message once an abnormal situation occurs to the electronic apparatus and provides an interactive question according to the type of the abnormal situation. Next, the method receives responses from the user aimed at the interactive question, and obtains one or more causes of the abnormal situation according to the replies to the interactive questions. Eventually, the method displays the obtained causes on a mobile device of the user.

Compare with other prior arts in the same field, the causes of an abnormal situation in an electronic apparatus are obtained via the corresponding replies to interactive questions by a user, whereby the accuracy of the causes of the abnormal situation provided to the user is increased.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is an operation architectural diagram according to the first embodiment of the present invention;

FIG. 2 is an alerting flowchart according to the first embodiment of the present invention;

FIG. 3A is a schematic diagram of a first alerting action according to the first embodiment of the present invention;

FIG. 3B is a schematic diagram of a second alerting action according to the first embodiment of the present invention;

FIG. 3C is a schematic diagram of a third alerting action according to the first embodiment of the present invention;

FIG. 3D is a schematic diagram of a fourth alerting action according to the first embodiment of the present invention;

FIG. 3E is a schematic diagram of a fifth alerting action according to the first embodiment of the present invention;

FIG. 3F is a schematic diagram of a sixth alerting action according to the first embodiment of the present invention;

FIG. 3G is a schematic diagram of a seventh alerting action according to the first embodiment of the present invention;

FIG. 4 is an alerting system architecture diagram according to the first embodiment of the present invention;

FIG. 5 is an alerting flowchart according to the second embodiment of the present invention;

FIG. 6 is a question processing flowchart according to the first embodiment of the present invention;

FIG. 7A is a schematic diagram of a first inquiry action according to the first embodiment of the present invention;

FIG. 7B is a schematic diagram of a second inquiry action according to the first embodiment of the present invention;

FIG. 7C is a schematic diagram of a third inquiry action according to the first embodiment of the present invention; and

FIG. 7D is a schematic diagram of a fourth inquiry action according to the first embodiment of the present invention.

### DETAILED DESCRIPTION OF THE INVENTION

In cooperation with attached drawings, the technical contents and detailed description of the present invention are described thereinafter according to a preferable embodiment, being not used to limit its executing scope. Any equivalent variation and modification made according to appended claims is all covered by the claims claimed by the present invention.

An interactive alerting method for an electronic apparatus (referred as the alert method in the following) is disclosed according to the present invention, which is used for monitoring the operation status of the electronic apparatus and performing alerting in the mobile devices carried by the users when abnormal situations occur to the electronic apparatuses.

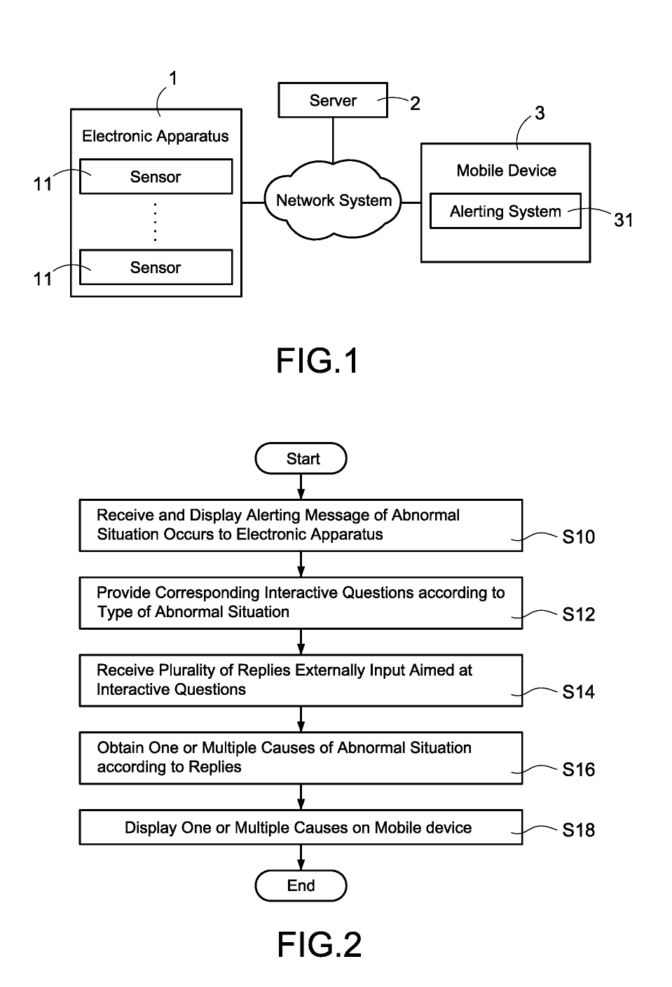

FIG. 1 is an operation architectural diagram according to the first embodiment of the present invention. The embodiment in FIG. 1 includes an electronic apparatus 1, a server 2 and a mobile device 3. The electronic apparatus 1 is installed with one or multiple sensors 11 used for sensing various data of the electronic apparatus 1, the server 2 determines if abnormal situations occur to the electronic apparatus 1 according to the sensor data of the sensors 11. The mobile device 3 is installed with an alerting system 31, and the alert method of the present invention is implemented via executing the alerting system 31 with the mobile device 3. In an embodiment, the alerting system 31 is software, which is an application program installed in the mobile device 3 but the scope is not limited thereto.

In an embodiment, the sensors 11 may include a current sensor used for sensing current data of the electronic apparatus 1, a voltage sensor used for sensing the voltage data of the electronic apparatus 1, a temperature sensor used for sensing internal temperature of the electronic apparatus 1, a temperature sensor used for sensing the ambient temperature of the electronic apparatus 1, a vibration sensor used for sensing the vibration frequency of the electronic apparatus 1, a power sensor used for sensing the output power of the electronic apparatus 1, and the power ON/OFF sensor used for sensing the power ON/OFF status of the electronic apparatus 1, but the scope is not limited thereto.

In the embodiment shown in FIG. 1, the sensors 11 continue to sense various data of the electronic apparatus 1 to generate a plurality of sensor data to send to the server 2. The server 2 determines if abnormal situations occur to the electronic apparatus 1 according to the contents of the sensor data (for example, the temperature or the current value is too high), and the server 2 sends an alerting message to the mobile device 3 when an abnormal situation is determined to occur. Therefore, the mobile device 3 may implement the alert method of the present invention by executing the alerting system 31.

FIG. 2 is an alerting flowchart according to the first embodiment of the present invention. In the embodiment shown in FIG. 2, the alerting system 31 first receives an alerting message aimed at an abnormal situation occur to the electronic apparatus 1 and displays the alerting message on the mobile device 3 (step S10). Next, the alerting system 31 provides a plurality of interactive questions (questionnaires) according to the type of the abnormal situation, and displays the interactive questions on the mobile device 3 (step S12). Specifically, the alerting system 31 displays the interactive questions and corresponding reply options (for example, “Yes” and “No”) simultaneously on the mobile device 3. The user reads the interactive questions on the mobile device 3 and replies to the interactive questions via triggering the reply options.

After step S12, the alerting system 31 may receive a plurality of replies externally input corresponding to the plurality of interactive questions (step S14), i.e. receiving the replies made by the user via triggering the reply options. After the user replies to all interactive questions, the alerting system 31 further obtains one or multiple causes of the abnormal situation according to the plurality of replies (step S16), and the one or multiple causes are displayed on the mobile device 3 (step S18).

Specifically, an abnormal situation may have many different causes (for example, causes of an abnormal vibration of an electronic apparatus can be imbalance of rotation body, moving parts, pulley shift, incorrect centering, insufficient base strength, vibration near an apparatus, shaft bending, uneven footings, etc.). It can be undesirable to a user to understand the abnormal situation and perform maintenance if all potential causes of the abnormal situation are displayed on the mobile device 3 without any filtering after acknowledging the abnormal situation occurs.

In terms of the above mentioned problems, the alert method used in the embodiment according to the present invention obtains and provides the interactive questions related to the type of the abnormal situation (such as an abnormal voltage, an abnormal current, an abnormal temperature, an abnormal vibration, an abnormal power etc.) and filters the known potential causes according to the replies to the interactive questions made by the user. Accordingly, the causes displayed on the mobile device 3 are the filtered causes for user's reference to more accurately understand the real situation of the electronic apparatus 1 and helps with resolving the abnormal situation occurs to the electronic apparatus 1.

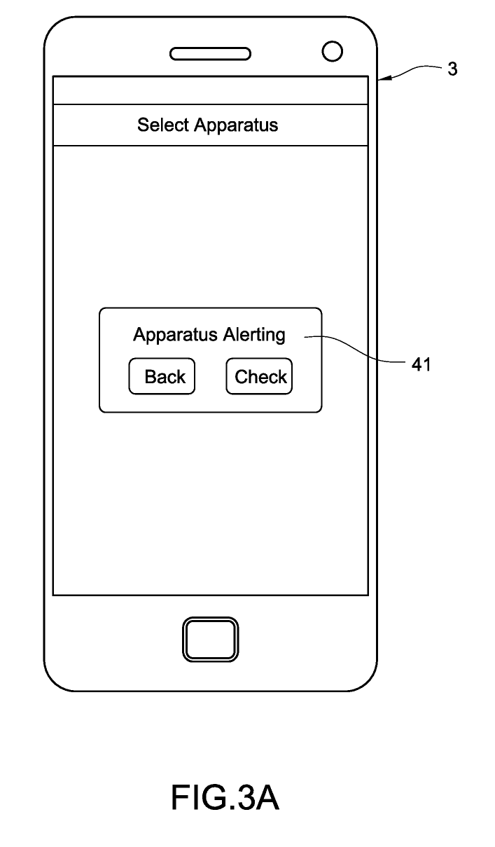

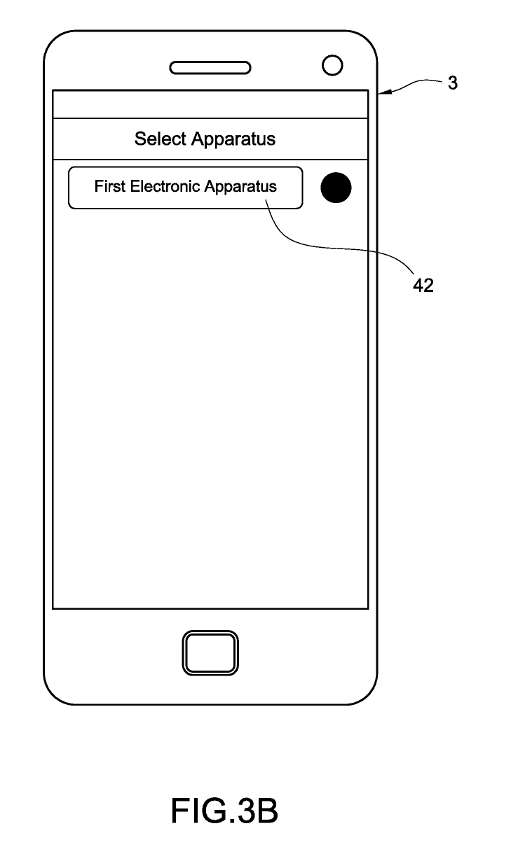

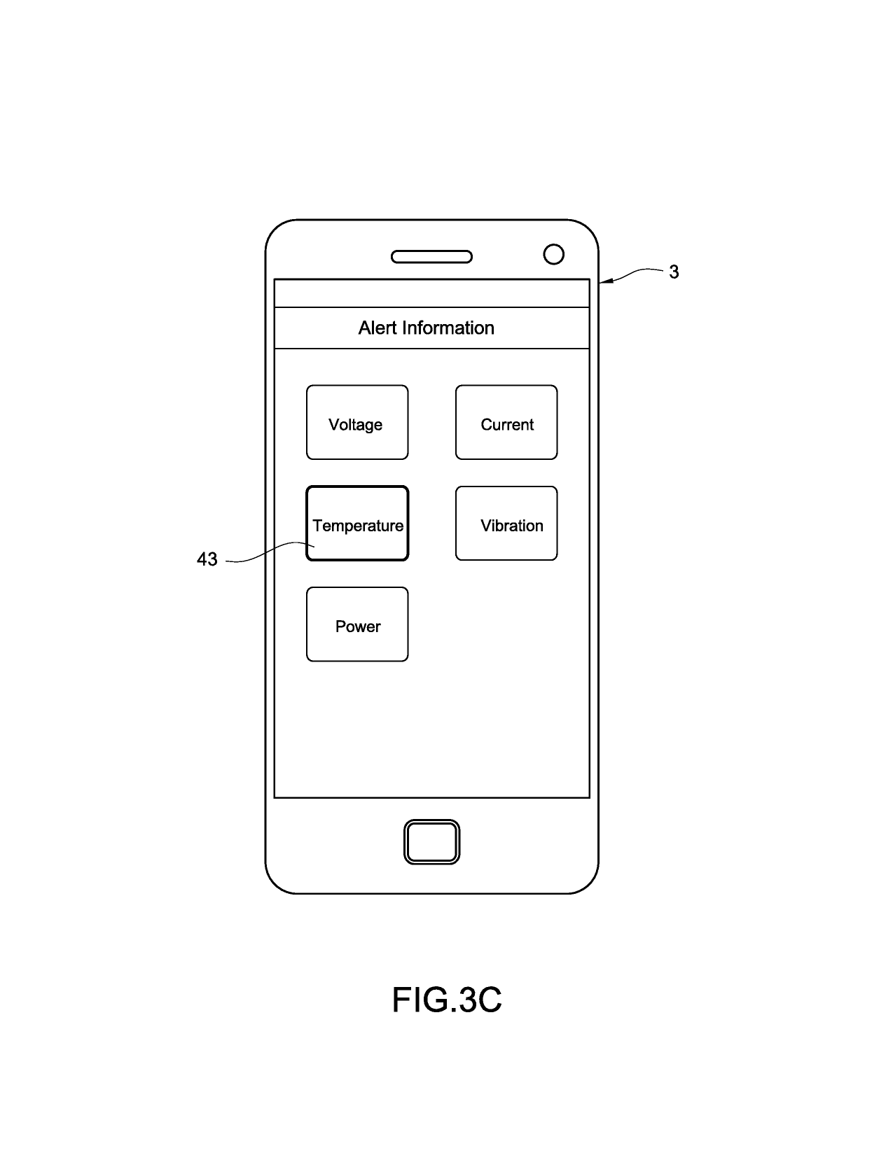

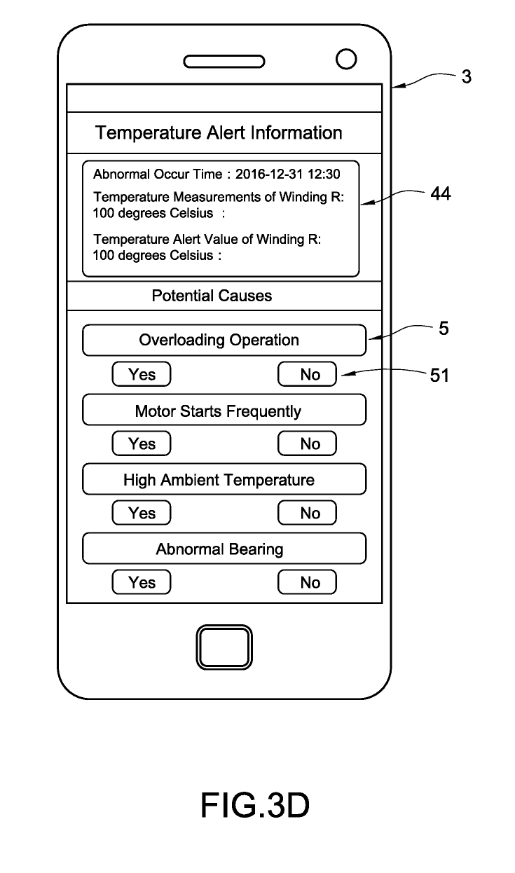

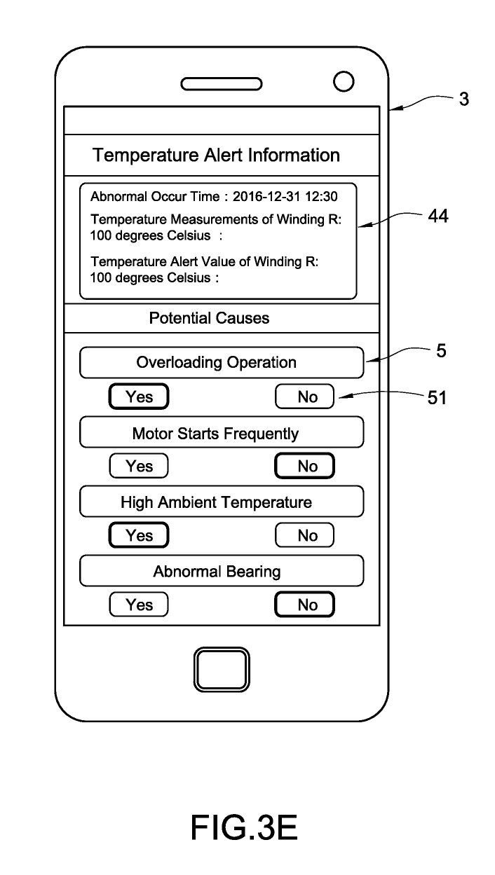

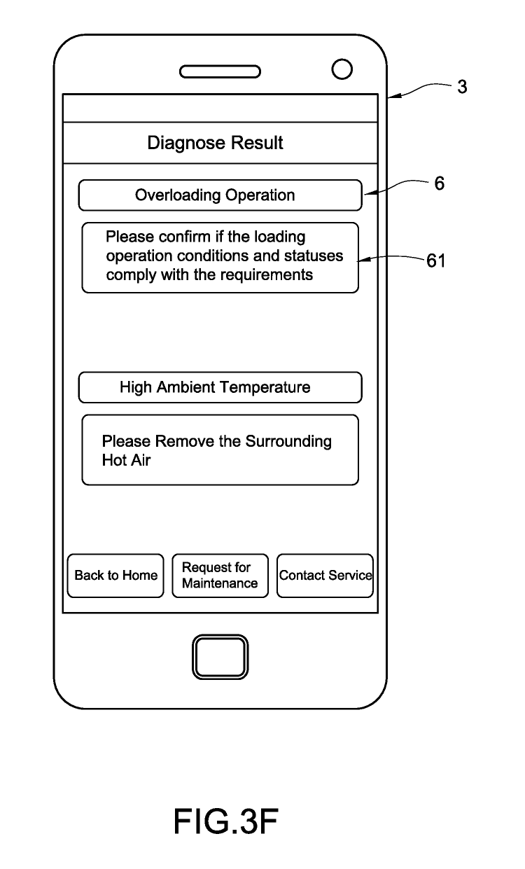

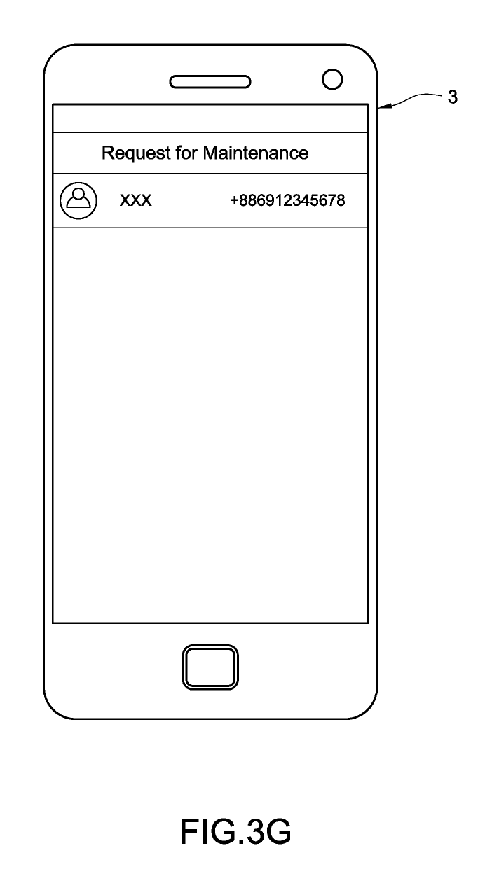

FIG. 3A to FIG. 3G are schematic diagrams of a first alerting action to a seventh alerting action according to the first embodiment of the present invention. In an embodiment, the alerting message displayed on the mobile device 3 by the alerting system 31 comprises an alert notification 41, an alert apparatus 42, an alert type 43, and alert contents 44. The alert apparatus 42 is used for describing the apparatus name or the apparatus ID of the electronic apparatus 1 where the abnormal situation occurs, the alert type 43 is used for describing the type of the abnormal situation, and the alert contents 44 are used for describing the specific contents of the abnormal situation.

As shown in FIG. 3A, when the alerting system 31 receives and displays the alerting message, the alerting system 31 first displays the alert notification 41 to remind user that an abnormal situation occurs.

As shown in FIG. 3B, when the user triggers the alert notification 41, the alerting system 31 further displays the alert apparatus 42 to inform the user of the apparatus name or the apparatus ID of the electronic apparatus 1 where the abnormal situation occurs. In the embodiment shown in FIG. 3B, displaying a first electronic apparatus is used as an example, but the scope is not limited thereto.

As shown in FIG. 3C, after the user triggered the alert notification 42, the alerting system 31 further displays the alert type 43 to inform the user of the type of the abnormal situation occurs to the electronic apparatus 1 (e.g., the first electronic apparatus). In an embodiment, the type of the abnormal situation may be, for example, abnormal voltages, abnormal currents, abnormal temperatures, abnormal vibrations, and abnormal powers, etc. In the embodiment shown in FIG. 3C, the exemplary type of the abnormal situation is an abnormal temperature, but the scope is not limited thereto.

As shown in FIG. 3D, after the user triggered the alert type 43, the alerting system 31 further displays the alert contents 44 to inform the user of specific contents of the abnormal situation. In the embodiment shown in FIG. 3D, the alert contents comprise occur time of the abnormal situation occurs to the electronic apparatus 1, sensor data of the electronic apparatus 1, and alert data.

In the embodiment, the type of the abnormal situation is an abnormal temperature. Accordingly, the sensor data is temperature measurements and the alert data is a temperature alert value. Specifically, in the embodiment shown in FIG. 3D, the sensor data is the temperature measurements of winding R of the electronic apparatus 1, and the alert data is temperature alert value of the winding R of the electronic apparatus 1. However, in other embodiments, the temperature measurements and the temperature alert value can be the temperature values of other components within the electronic apparatus 1 or the ambient temperature values around the electronic apparatus 1, and the scope is not limited by the example shown in FIG. 3D.

As shown in FIG. 3D, when the alerting system 31 displays the alert contents 44, the alerting system 31 also displays a plurality of interactive questions 5 on the mobile device 3. Specifically, the alerting system 31 displays the plurality of interactive questions 5 related to the alert type 43. In the embodiment shown in FIG. 3D, the interactive questions 5 related to the abnormal temperature of the electronic apparatus 1 comprise overloading usages, motor starts frequently, high ambient temperatures, abnormal bearings, etc., but the scope is not limited thereto.

As shown in FIG. 3E, once the alerting system 31 displays the plurality of interactive questions 5, the user may operate the mobile device 3 to reply to the plurality of interactive questions 5. Specifically, once the alerting system 31 displays the plurality of interactive questions 5, the alerting system 31 simultaneously displays corresponding reply options 51 (i.e. as the “yes” or “no” options shown in FIG. 3E), the user may trigger the reply options 51 to reply to the plurality of interactive questions 5.

As shown in FIG. 3F, when the alerting system 31 receives the replies to the plurality of interactive questions 5 made by the user, the alerting system 31 obtains and filters the one or multiple abnormality causes 6 of the abnormal situation according to the replies then displays the one or multiple abnormality causes 6 on the mobile device 3. In an embodiment, when obtaining the one or multiple abnormality causes 6, the alerting system 31 simultaneously obtains corresponding solutions 61 to the one or multiple abnormality causes 6 and displays the solutions 61 in company with the one or multiple abnormality causes 6.

It should be noted that if the user does not have the administrative authority of the electronic apparatus 1 or the user cannot maintain the electronic apparatus 1, the alerting system 31 can further provide an option of maintenance request on the mobile device 3. When the user triggers the option of maintenance request, the alerting system 31 goes to a request for maintenance page as shown in FIG. 3G The request for maintenance page indicates the contact information of one or several maintenance staffs. Thus, after the user receives the alerting message with the mobile device 3, the user can conveniently inform the maintenance staffs to go to the location of the electronic apparatus 1 to perform maintenance.

In the above mentioned embodiments, the alerting system 31 is installed and operated in the mobile device 3 as an application program in the mobile device 3. Nonetheless, in other embodiments, the alerting system 31 is implemented respectively or simultaneously via different devices.

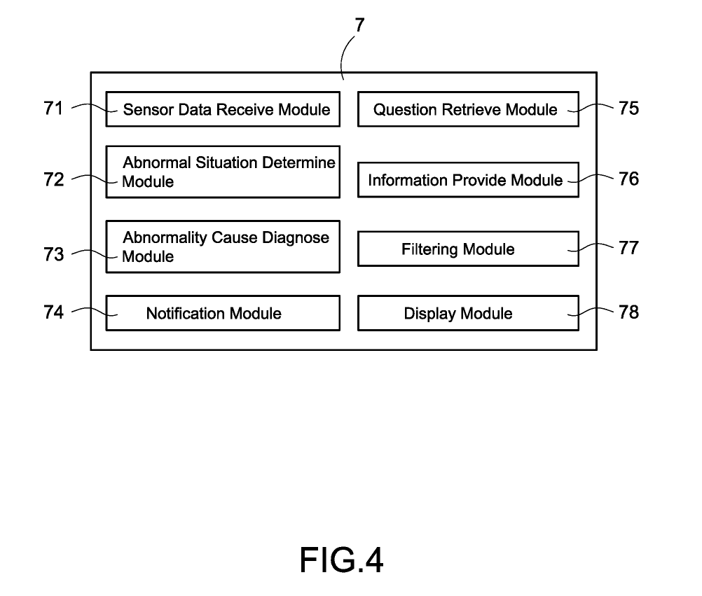

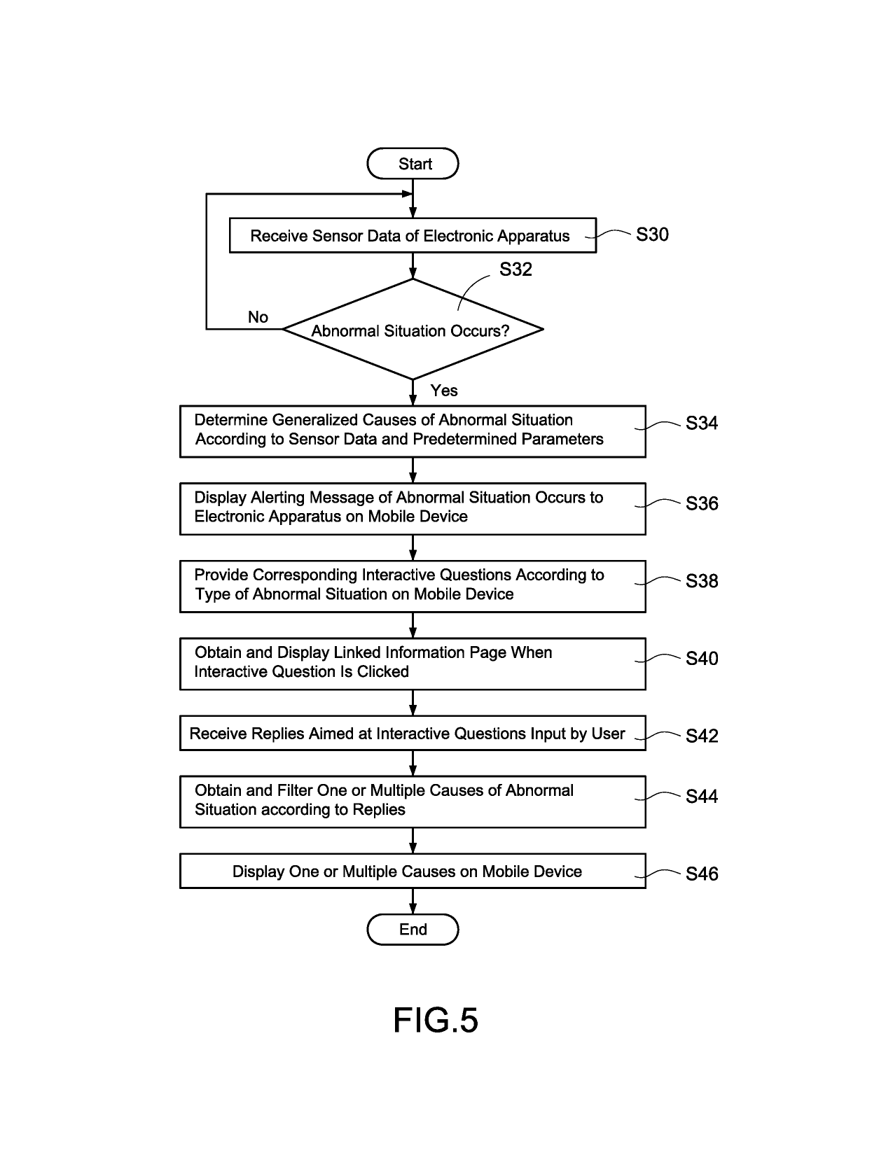

FIG. 4 and FIG. 5 are an alerting system architecture diagram according to the first embodiment of the present invention and an alerting flowchart according to the second embodiment of the present invention. The embodiment shown in FIG. 4 discloses another alerting system 7. The alerting system 7 comprises a sensor data receive module 71, an abnormal situation determine module 72, an abnormality cause diagnose module 73, a notification module 74, a question retrieve module 75, an information provide module 76, a filtering module 77, and a display module 78. The aforementioned modules can be respectively implemented in forms of software or hardware and the quantity and types of the modules 71-78 can be increased, decreased or modified as required in field and is not limited by the example shown in FIG. 4.

In an embodiment, the modules 71-78 in the alerting system 7 independently operate in the mobile device 3 (i.e., the alerting system 7 is similar to or identical to the alerting system 31 shown in FIG. 1) so as to simplify the system architecture. In other embodiments, the modules 71-78 in the alerting system 7 may respectively operate in the server 2 and the mobile device 3, or may respectively operate in the electronic apparatus 1, the server 2 and the mobile device 3 so as to reduce the loading of the mobile device 3. Because the server 2 usually has the computing efficiency higher than that of the mobile device 3, the time length between realizing an abnormal situation occurs and sending an alerting message is effectively reduced and the accuracy of the alerting message is increased when the server 2 is responsible for executing the computing in the alerting system 7.

Another embodiment of the alert method is illustrated below accompanying the alerting system 7 shown in FIG. 4 and the alerting flowchart shown in FIG. 5.

Firstly, the alerting system 7 receives a plurality of sensor data of the electronic apparatus 1 via the sensor data receive module 71 (step S30), for example voltage data, current data and temperature data, etc. The abnormal situation determine module 72 connects to the sensor data receive module 71, and determines if an abnormal situation occurs to the electronic apparatus 1 according to the sensor data received by the sensor data receive module 71 (step S32). In an embodiment, the abnormal situation determine module 72 performs comparison between the sensor data and the predetermined multiple threshold values (for example compare with a voltage alert value, a current alert value, a temperature alert value, etc.), and determines an abnormal situation occurs to the electronic apparatus 1 when any of the sensor data exceeds the corresponding threshold value.

If the abnormal situation determine module 72 determines the electronic apparatus 1 operates normally, the alert method returns to the step 30 to receive the sensor data and determine if an abnormal situation occurs to the electronic apparatus 1 continually.

If the abnormal situation determine module 72 determines an abnormal situation occurs to the electronic apparatus 1 according to the sensor data, then the abnormality cause diagnose module 73 proceeds to diagnose the abnormal situation. Specifically, the abnormality cause diagnose module 73 connects to the abnormal situation determine module 72, which is used for determining multiple generalized causes of the abnormal situation according to the plurality of sensor data and a predetermined parameter when the abnormal situation occurs (step S34).

In an embodiment, the alerting system 7 pre-saves one or multiple parameters in the server 2 or the mobile device 3, and sets up corresponding generalized causes of each predetermined parameter according to the past experiences. For example, when the vibration level of the electronic apparatus 1 exceeds a first predetermined parameter, the generalized causes may include imbalance of rotation body, moving parts, pulley shift, incorrect centering, insufficient base strength, vibration near an apparatus, shaft bending, uneven footings, etc.

As mentioned above, there is a huge number of the potential generalized causes, and the generalized causes may not be directly related to the abnormal situation that occurs to the electronic apparatus 1. Accordingly, the alerting system 7 of the present invention does not directly offer the generalized causes to the users such that the user is not confused by the excess information.

In an embodiment, the above mentioned sensor data receive module 71, the abnormal situation determine module 72 and the abnormality cause diagnose module 73 are executed in the server 2. Thus, the server 2 continues to monitor each data of the electronic apparatus 1, and continues to determine if an abnormal situation occurs to the electronic apparatus 1 so as to effectively lower the computing loading of the mobile device 3.

In an embodiment, the above mentioned sensor data receive module 71, the abnormal situation determine module 72 and the abnormality cause diagnose module 73 are executed in the mobile device 3. Thus, the alerting system 7 may directly monitor the electronic apparatus 1 without the server 2 and perform alerting in the mobile device when an abnormal situation occurs in order to simplify the system architecture and reduce the communication time.

In an embodiment, the alerting system 7 may not include the above mentioned sensor data receive module 71, the abnormal situation determine module 72 and the abnormality cause diagnose module 73. Specifically, the electronic apparatus 1 is monitored by another monitor system (not shown in the diagrams), and the monitor system directly sends information such as the sensor data, the type of the abnormal situation and the contents, etc. to the alerting system 7 after an abnormal situation occurs to the electronic apparatus 1, and then the alerting system 7 continues to perform the following alerting operations. Thus, the development and maintenance cost of the alerting system 7 is effectively lowered.

As mentioned above, when an abnormal situation occurs to the electronic apparatus 1, the alerting system 7 displays an alerting message aimed at the abnormal situation occurs to the electronic apparatus 1 on the mobile device 3 via the notification module 74 (step S36). The alerting message comprises the alert notification 41, the alert apparatus 42, the alert type 43, and the alert contents 44 as shown from FIG. 3A to FIG. 3D.

The question retrieve module 75 is connected to the notification module, 74. When the alerting system 7 sends the alerting message via the notification module 74, the question retrieve module 75 provides a plurality of interactive questions according to the type of the abnormal situation on the mobile device 3 (step S38). The interactive questions are similar to or identical to the interactive questions 5 as shown in FIG. 3D.

It should be noted that different types of the abnormal situations may have different causes, and certain types of the abnormal situations may result from same cause(s) (for example, motor starts frequently may result in both an abnormal temperature and an abnormal current). Therefore, the contents of the plurality of interactive questions provided according to different types by the question retrieve module 75 may be the same or the different.

When providing the plurality of interactive questions, the question retrieve module 75 may also retrieve and provide corresponding reply options to each interactive question to be the user's reply reference. The reply options are similar to or identical to the reply options shown in FIG. 3E.

The information provide module 76 is connected to the question retrieve module 75. In an embodiment, the information provide module 76 obtains and displays an information page linked to a clicked interactive question when one of the pluralities of interactive questions is clicked by the user (step S40). The information page is used for displaying the apparatus information related to the clicked interactive questions (details in the following). Thus, the user may read the apparatus information displayed on the information page and be informed of the operation status of the electronic apparatus 1 (for example, the current data values or curve diagrams within the last 8 hours or the temperature data values or curve diagrams within the last 24 hours, etc.), and further replies to the clicked interactive questions through the reply options by reference to the apparatus information. Thus, the question retrieve module 75 receives the plurality of replies to the plurality of interactive questions input by the user on the mobile device 3 (step S42).

The filtering module 77 is connected to the question retrieve module 75. When the user replies to all the interactive questions provided by the question retrieve module 75, the filtering module 77 obtains one or multiple causes of the abnormal situation according to the plurality of replies (step S44). In addition, the filtering module 77 respectively obtains the corresponding solutions to the one or multiple causes.

In an embodiment, the filtering module 77 filters the multiple generalized causes determined by the abnormality cause diagnose module 73 according to the plurality of replies in order to obtain one or multiple causes that really matter. In the embodiment, the quantity of the one or multiple causes is less than the quantity of the multiple generalized causes. For example, when one of the multiple generalized causes is the high surrounding ambient temperature, and the user's reply to the interactive question “if the high surrounding ambient temperature is too high” is “No”, then the filtering module 77 filters the cause for preventing the cause from being shown on the mobile device 3.

The display module 78 is connected to the filtering module 77. In an embodiment, the display module 78 is used for displaying the one or multiple causes filtered by the filtering module 77 on the mobile device 3 (step S46). In addition, the display module 78 also displays the corresponding solutions to the one or multiple causes. The alert method and alerting system of the present invention filter the potential causes of the abnormal situation via the replies to the interactive questions and only display the filtered causes, whereby the user is allowed to directly obtain the exact cause(s) of the abnormal situation that occurs to the electronic apparatus 1.

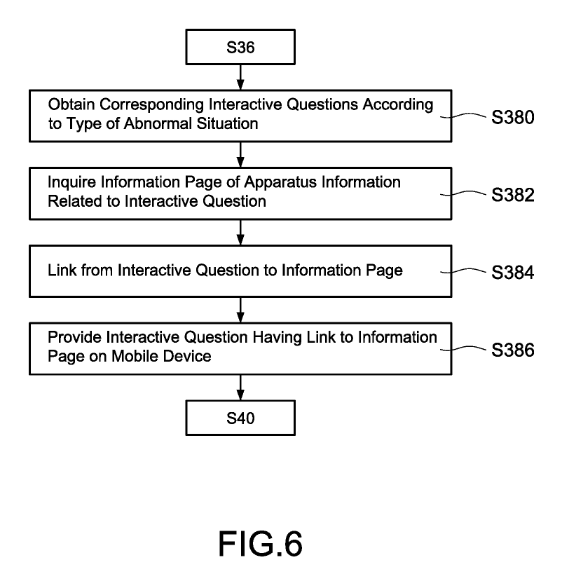

FIG. 6 is a question processing flowchart according to the first embodiment of the present invention. The embodiment shown in FIG. 6 is used for illustrating step S38 shown in FIG. 5.

Specifically, as shown in FIG. 6, when the notification module 74 sends the alerting message on the mobile device 3, the question retrieve module 75 obtains the corresponding plurality of interactive questions from a database (not shown in the diagrams) according to the type of the abnormal situation (step S380). Next, the information provide module 76 respectively inquiries the information pages of the apparatus information related to each interactive question (step S382).

After step S382, the question retrieve module 75 and/or the information provide module 76 link each interactive question to each related information page (step S384), then provide the plurality of interactive questions having links to the related information pages on the mobile device 3 (S386). Accordingly, when each interactive question is triggered by the user on the mobile device 3, the mobile device 3 automatically switches and displays the information page linked to the triggered interactive question and the user is allowed to inquire and read apparatus information related to the triggered interactive question.

With the aforementioned technical features, the user may reply to the interactive questions and enter into each information page of the electronic apparatus 1 to check the apparatus information and memorize the information without exist the menu, then return to the interactive questions page and reply to the interactive questions through triggering the reply options. Thus, the reply efficiency, accuracy and usage convenience is effectively increased.

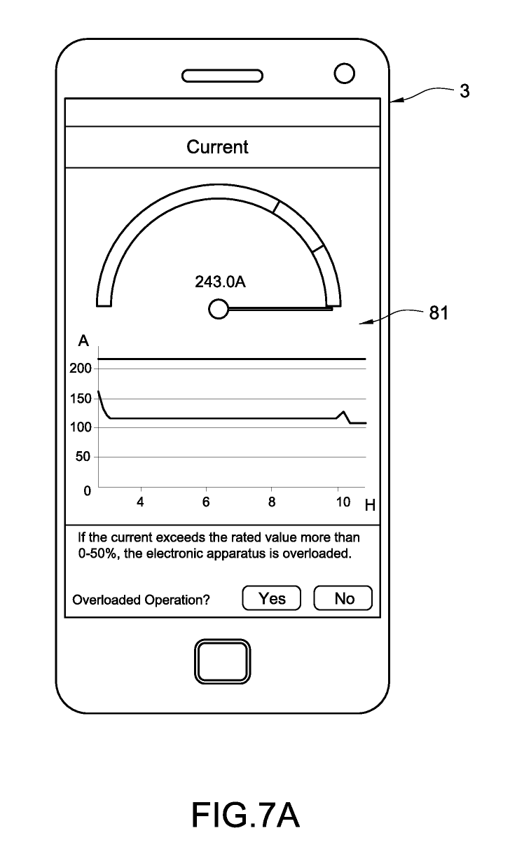

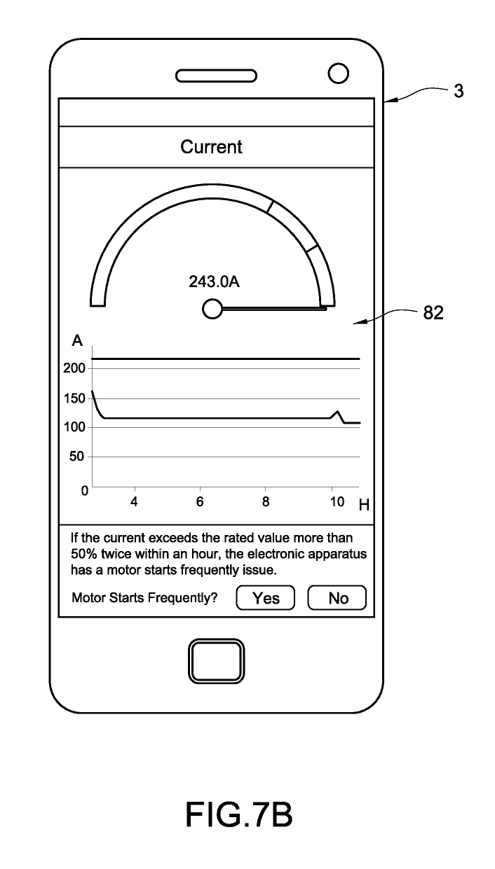

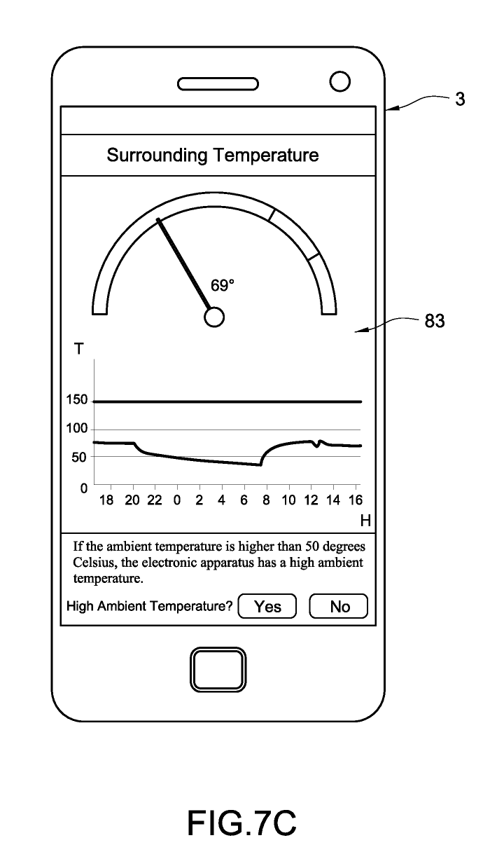

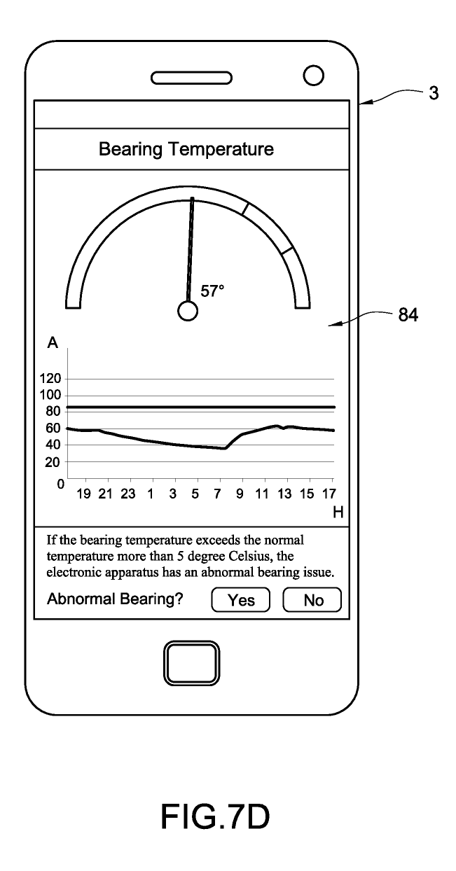

FIG. 7A-7D are schematic diagrams from a first inquiry action to a fourth inquiry action according to the first embodiment of the present invention.

As shown in FIG. 7A, when the user triggers a first interactive question displayed on the mobile device 3 (for example, inquire if the electronic apparatus 1 was overloaded), the mobile device 3 automatically switches to a first information page 81 linked with the first interactive question, and displays the apparatus information related to the first interactive question on the first information page 81. In the embodiment, the apparatus information is the current data of the electronic apparatus 1, which helps the user to determine if the electronic apparatus 1 was overloaded.

As shown in FIG. 7B, when the user triggers a second interactive question displayed on the mobile device 3 (for example, inquire if the electronic apparatus 1 has a motor starts frequently issue), the mobile device 3 automatically switches to a second information page 82 linked with the second interactive question, and displays the apparatus information related to the second interactive question on the second information page 82. In the embodiment, the apparatus information is the current data of the electronic apparatus 1, which helps the user to determine if the electronic apparatus 1 has a motor starts frequently issue.

As shown in FIG. 7C, when the user triggers a third interactive question displayed on the mobile device 3 (for example, inquire if the electronic apparatus 1 was under a high surrounding temperature), the mobile device 3 automatically switches to a third information page 83 linked with the third interactive question, and displays the apparatus information related to the third interactive question on the third information page 83. In the embodiment, the apparatus information is the ambient temperature data of the electronic apparatus 1, which helps the user to determine if the electronic apparatus 1 was under high surrounding temperature.

As shown in FIG. 7D, when the user triggers a fourth interactive question displayed on the mobile device 3 (for example, inquire if the electronic apparatus 1 has an abnormal bearing issue), the mobile device 3 automatically switches to a fourth information page 84 linked with the fourth interactive question, and displays the apparatus information related to the fourth interactive question on the fourth information page 84. In the embodiment, the apparatus information is the shaft temperature data of the electronic apparatus 1, which helps the user to determine if the electronic apparatus 1 has an abnormal bearing issue.

Each embodiment of the present invention provides corresponding interactive questions according to the type of an abnormal situation occurs to an electronic apparatus, and filters various potential causes according to the replies made by the user aimed at the interactive questions, which conveniently helps the user to directly obtain the exact cause of the abnormal situation and the corresponding solution.

As the skilled person will appreciate, various changes and modifications can be made to the described embodiment. It is intended to include all such variations, modifications and equivalents which fall within the scope of the present invention, as defined in the accompanying claims.

What is claimed is:

1. An interactive alerting method for an electronic apparatus comprising:
a) displaying an alerting message corresponding to an abnormal situation of an electronic apparatus on a mobile device;
b) providing a plurality of interactive questions according to a type of the abnormal situation;
c) receiving a plurality of replies externally input aimed at the plurality of interactive questions;
d) obtaining one or multiple causes of the abnormal situation according to the plurality of replies; and
e) displaying the one or multiple causes on the mobile device.

2. The interactive alerting method for an electronic apparatus of claim 1, wherein the alerting message comprises an alert notification, an alert apparatus, an alert type and alert contents, wherein, the alert apparatus describes the apparatus name of the electronic apparatus, the alert type describes the type of the abnormal situation occurs to the electronic apparatus, and the alert contents describes specific contents of the abnormal situation.

3. The interactive alerting method for an electronic apparatus of claim 1, wherein one or multiple solutions corresponding to the one or multiple causes are also obtained in the step d), and the one or more solutions corresponding to the one or multiple causes are also displayed on the mobile device in the step e).

4. The interactive alerting method for an electronic apparatus of claim 1, wherein the step a) further comprises the following steps:
a01) receiving a plurality of sensor data of the electronic apparatus;
a02) determining if the abnormal situation occurs to the electronic apparatus according to the plurality of sensor data; and
a03) determining multiple generalized causes of the abnormal situation according to the plurality of sensor data and a predetermined parameter when the abnormal situation is determined to occur.

5. The interactive alerting method for an electronic apparatus of claim 4, wherein the multiple generalized causes are filtered according to the plurality of replies in order to obtain the one or multiple causes in the step d), and the one or multiple filtered causes are displayed on the mobile device in the step e), wherein the quantity of the one or multiple filtered causes is less than the quantity of the multiple generalized causes.

6. The interactive alerting method for an electronic apparatus of claim 5, further comprising a step f): obtaining and displaying an information page linked to a clicked interactive question when one of the pluralities of interactive questions is clicked, wherein the information page displays apparatus information of the electronic apparatus related to the clicked interactive question.

7. The interactive alerting method for an electronic apparatus of claim 6, wherein the step b further comprises the following steps:
b01) obtaining the plurality of interactive questions corresponding to the abnormal situation according to the type of the abnormal situation;
b02) respectively inquiring the information page of the apparatus information related to each of the interactive questions;
b03) linking each interactive question to each information page; and
b04) displaying each of the interactive questions on the mobile device.

8. An interactive alerting system for an electronic apparatus comprising:
a notification module for displaying an alerting message corresponding to an abnormal situation of an electronic apparatus on a mobile device;
a question retrieve module connected to the notification module, providing a plurality of interactive questions according to a type of the abnormal situation, and receiving a plurality of replies externally input aimed at the plurality of interactive questions;
a filtering module connected to the question retrieve module, obtaining one or multiple causes of the abnormal situation according to the plurality of replies; and
a display module connected to the filtering module, displaying the one or multiple causes on the mobile device.

9. The interactive alerting system for an electronic apparatus of claim 8, further comprising:
a sensor data receive module, receiving a plurality of sensor data of the electronic apparatus;
an abnormal situation determine module connected to the sensor data receive module, determining if the abnormal situation occurs to the electronic apparatus according to the plurality of sensor data; and
an abnormality cause diagnose module connected to the abnormal situation determine module, determining multiple generalized causes of the abnormal situation according to the plurality of sensor data and a predetermined parameter when the abnormal situation is determined to occurs, wherein the filtering module filters the multiple generalized causes according to the plurality of replies in order to obtain the one or multiple causes, and the quantity of the one or multiple filtered causes is less than the quantity of the multiple generalized causes.

10. The interactive alerting system for an electronic apparatus of claim 9, further comprising: an information provide module connected to the question retrieve module, obtaining and displaying an information page linked to a clicked interactive question when one of the plurality of interactive questions is clicked, wherein the information page displays apparatus information of the electronic apparatus related to the clicked interactive question.
